(19) United States
(12) Patent Application Publication
(10) Pub. No.: US 2026/0127687 A1
(43) Pub. Date: May 7, 2026

(54) ENERGY-SAVING MONITORING METHODS AND INTERNET OF THINGS SYSTEMS FOR INTELLIGENT GAS PIPELINE DEVICES

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Feng WANG, Chengdu (CN); Zhubin CHENG, Chengdu (CN)

(73) Assignee: CHENGDU QINCHUAN IOT TECHNOLOGY CO., LTD., Chengdu (CN)

(21) Appl. No.: 19/434,067

(22) Filed: Dec. 29, 2025

(30) Foreign Application Priority Data
Nov. 17, 2025 (CN) 202511676384.3

(51) Int. Cl. G06Q 50/06; G16Y 40/10

(52) U.S. Cl. CPC G06Q 50/06; G16Y 40/10

(57) ABSTRACT

An energy-saving monitoring method for an intelligent gas pipeline device is provided. The method is executed by a gas company management platform of an energy-saving monitoring Internet of Things (IoT) system for the intelligent gas pipeline device. The method may include: obtaining importance levels of a plurality of gas pipelines from a data center of a government safety management sub-platform, invoking device information of a plurality of sets of monitoring devices corresponding to the plurality of gas pipelines, and determining a monitoring strategy based on the importance levels and the device information; determining a target device among the plurality of sets of monitoring devices and an energy-saving level corresponding to the target device at least based on the monitoring strategy, and determining an energy-saving control parameter based on the energy-saving level; and generating a control instruction based on the energy-saving control parameter.

### CROSS-REFERENCE TO RELATED APPLICATIONS

This application claims priority of Chinese Patent Application No. CN202511676384.3, filed on Nov. 17, 2025, the entire contents of which are hereby incorporated by reference.

### TECHNICAL FIELD

The present disclosure generally relates to the field of gas pipeline network operation, and in particular to an energy-saving monitoring method and Internet of Things (IoT) system for an intelligent gas pipeline device.

### BACKGROUND

To ensure the safe operation of gas pipeline networks, various devices are often installed along the gas pipelines to monitor, collect, and transmit relevant data. The operation of these devices relies on battery power. Without proper planning for their functioning, battery depletion may occur, necessitating on-site maintenance by personnel and disrupting normal data collection.

Therefore, it is desirable to provide an energy-saving monitoring method and an Internet of Things system for an intelligent gas pipeline device to better perform energy-saving management of devices in the gas pipeline network.

### SUMMARY

One or more embodiments of the present disclosure provide an energy-saving monitoring method for an intelligent gas pipeline device. The method is executed by a gas company management platform of an energy-saving monitoring IoT system for an intelligent gas pipeline device. The method includes: obtaining importance levels of a plurality of gas pipelines from a data center of a government safety management sub-platform, invoking device information of a plurality of sets of monitoring devices corresponding to the plurality of gas pipelines, and determining a monitoring strategy based on the importance levels and the device information, wherein each of the plurality of sets of monitoring devices includes a monitoring module and a communication module; determining a target device among the plurality of sets of monitoring devices and an energy-saving level corresponding to the target device at least based on the monitoring strategy, and determining an energy-saving control parameter based on the energy-saving level, wherein the energy-saving control parameter includes at least one of an operating mode of the target device, an energy-saving collection frequency, and a data transmission volume; and sending the energy-saving control parameter to an intelligent gas government safety supervision management platform, and generating a control instruction based on the energy-saving control parameter in response to obtaining confirmation information from the intelligent gas government safety supervision management platform. The control instruction is configured to control the target device to perform at least one of the following operations: controlling the communication module of the target device to turn on or turn off based on the operating mode in the energy-saving control parameter, controlling the target device to perform data collection according to the energy-saving collection frequency via the monitoring module, and controlling the target device to perform data transmission based on the data transmission volume via the communication module.

One or more embodiments of the present disclosure provide an energy-saving monitoring Internet of Things (IoT) system for an intelligent gas pipeline device. The IoT system may include: an intelligent gas government safety supervision management platform, an intelligent gas government safety supervision sensing network platform, an intelligent gas government safety supervision object platform, a gas company sensing network platform, and an intelligent gas appliance object platform. The intelligent gas government safety supervision object platform includes a gas company management platform, and the gas company management platform is configured to implement the aforementioned energy-saving monitoring method for an intelligent gas pipeline device.

One or more embodiments of the present disclosure provide a non-transitory computer-readable storage medium storing computer instructions. When reading the computer instructions in the storage medium, a computer may implement the energy-saving monitoring method for an intelligent gas pipeline device.

### BRIEF DESCRIPTION OF THE DRAWINGS

The present disclosure will be further illustrated by way of exemplary embodiments. These exemplary embodiments will be described in detail with reference to the accompanying drawings. These embodiments are not limiting. In these embodiments, the same reference numerals denote the same structures, wherein:

FIG. 1 is a schematic diagram illustrating a system structure of an energy-saving monitoring Internet of Things (IoT) system for an intelligent gas pipeline device according to some embodiments of the present disclosure;

FIG. 2 is a flowchart illustrating an exemplary process for an energy-saving monitoring method for an intelligent gas pipeline device according to some embodiments of the present disclosure;

FIG. 3 is a schematic diagram of determining a collection frequency according to some embodiments of the present disclosure;

FIG. 4 is a schematic diagram of an evaluation model according to some embodiments of the present disclosure; and

FIG. 5 is a schematic diagram illustrating an exemplary process for determining an energy-saving control parameter according to some embodiments of the present disclosure.

### DETAILED DESCRIPTION

In order to more clearly illustrate the technical solutions related to the embodiments of the present disclosure, a brief introduction of the drawings referred to in the description of the embodiments is provided below. Obviously, the drawings in the following description are merely some examples or embodiments of the present disclosure. For those of ordinary skill in the art, the present disclosure may be applied to other similar scenarios based on these drawings without creative efforts. Unless obviously obtained from the context or the context illustrates otherwise, the same numeral in the drawings refers to the same structure or operation.

It should be understood that the terms “system”, “device”, “unit”, and/or “module” used herein are methods for distinguishing components, elements, parts, sections, or assemblies of different levels. However, if other words may achieve the same purpose, the words may be replaced by other expressions.

The present disclosure uses flowcharts to illustrate operations performed by systems according to embodiments of the present disclosure. It should be understood that the preceding or following operations are not necessarily performed precisely in sequence. Instead, the steps may be processed in reverse order or simultaneously. Meanwhile, other operations may be added to these processes, or one or several operations may be removed from these processes.

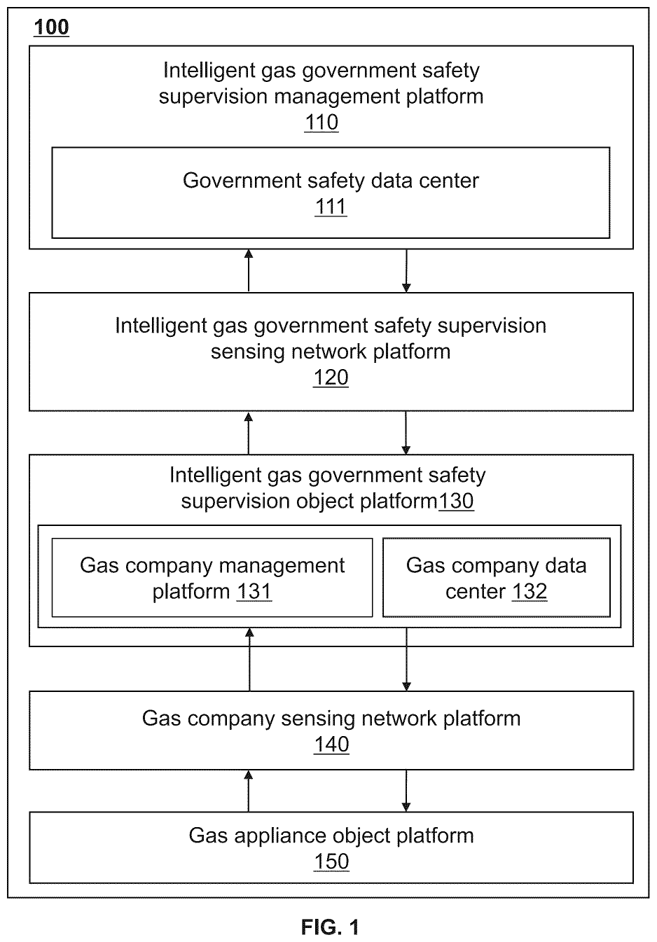

FIG. 1 is a schematic diagram illustrating a system structure of an energy-saving monitoring Internet of Things (IoT) system for an intelligent gas pipeline device according to some embodiments of the present disclosure.

In some embodiments, the energy-saving monitoring IoT system 100 for the intelligent gas pipeline device (also referred to an IoT system 100 or IoT system) may include an intelligent gas government safety supervision management platform 110, an intelligent gas government safety supervision sensing network platform 120, an intelligent gas government safety supervision object platform 130, a gas company sensing network platform 140, and a gas appliance object platform 150.

The intelligent gas government safety supervision management platform 110 refers to a functional platform for government safety departments to manage gas safety. In some embodiments, the intelligent gas government safety supervision management platform 110 includes a government safety data center 111. The government safety data center 111 refers to a database for storing data of the energy-saving monitoring IoT system 100 for the intelligent gas pipeline device. For example, the government safety data center 111 may store importance levels of a plurality of gas pipelines in a gas pipeline network, etc. In some embodiments, the intelligent gas government safety supervision management platform 110 is implemented based on a processor or a server.

In some embodiments, the intelligent gas government safety supervision management platform 110 may interact with the intelligent gas government safety supervision sensing network platform 120. For example, the intelligent gas government safety supervision management platform 110 may receive an energy-saving control parameter uploaded by the intelligent gas government safety supervision sensing network platform 120, and send confirmation information of the energy-saving control parameter to the intelligent gas government safety supervision sensing network platform 120.

The intelligent gas government safety supervision sensing network platform 120 is a functional platform for managing government sensing communication. In some embodiments, the intelligent gas government safety supervision sensing network platform 120 may be implemented based on communication equipment or a server. In some embodiments, the intelligent gas government safety supervision sensing network platform 120 may implement functions of sensing communication for perception information and sensing communication for control information.

In some embodiments, the intelligent gas government safety supervision sensing network platform 120 may interact with the intelligent gas government safety supervision object platform 130. For example, the intelligent gas government safety supervision sensing network platform 120 may receive an energy-saving control parameter uploaded by the intelligent gas government safety supervision object platform 130, and send confirmation information of the energy-saving control parameter issued by the intelligent gas government safety supervision management platform 110 to the intelligent gas government safety supervision object platform 130.

The intelligent gas government safety supervision object platform 130 is a platform for the government to generate supervision information and execute control information. In some embodiments, the intelligent gas government safety supervision object platform 130 may include a gas company management platform 131 (also known as company management platform 131 or company management platform). In some embodiments, the gas company management platform 131 may include a gas company data center 132. In some embodiments, the company management platform 131 may be configured as a server or a processor.

In some embodiments, the company management platform 131 may interact with the gas company sensing network platform 140. For example, the company management platform may obtain sensing data collected by a plurality of groups of monitoring devices of the gas appliance object platform 150 based on the gas company sensing network platform 140.

The gas company sensing network platform 140 is a platform for comprehensive management of sensing information of a gas company. In some embodiments, the gas company sensing network platform 140 may implement functions of sensing communication for perception information and sensing communication for control information. In some embodiments, the gas company sensing network platform 140 may be configured as at least one of a communication base station, a router, or a wireless WIFI device.

In some embodiments, the gas company sensing network platform 140 may be communicatively connected to the intelligent gas government safety supervision object platform 130 and the gas appliance object platform 150.

In some embodiments of the present disclosure, information operation in the energy-saving monitoring IoT system 100 can form a closed loop among various functional platforms. Under the centralized management of the gas company management platform, the information operation operates in a coordinated and regulated manner, achieving informatization and intellectualization of energy-saving monitoring for intelligent gas pipeline devices.

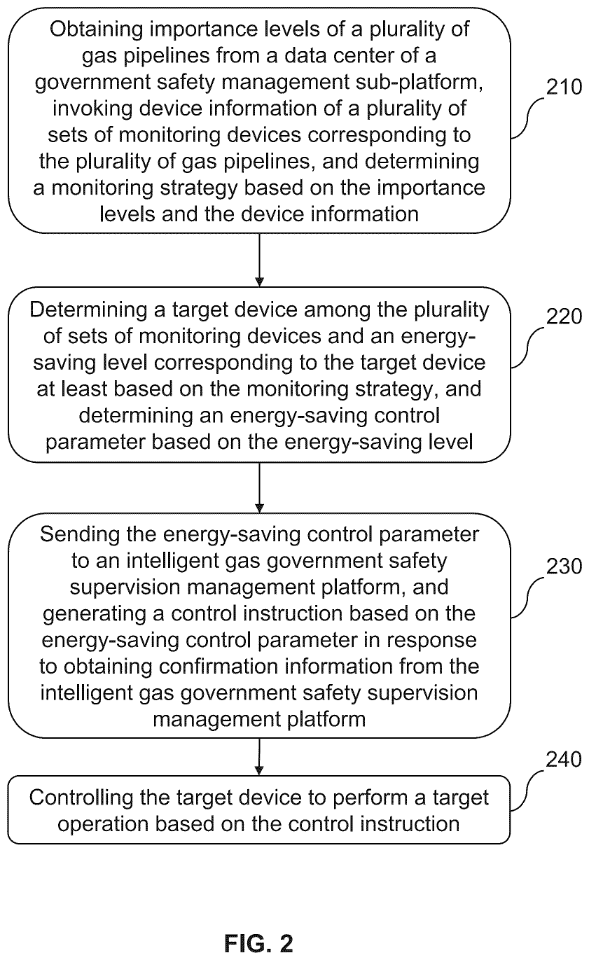

FIG. 2 is a flowchart illustrating an exemplary process for an energy-saving monitoring method for an intelligent gas pipeline device according to some embodiments of the present disclosure. As shown in FIG. 2, the energy-saving monitoring method for the intelligent gas pipeline device includes the following steps. In some embodiments, the energy-saving monitoring method for the intelligent gas pipeline device may be performed by the gas company management platform 131.

In step 210, importance levels of a plurality of gas pipelines are obtained from a data center of a government safety management sub-platform, device information of a plurality of sets of monitoring devices corresponding to the plurality of gas pipelines is invoked, and a monitoring strategy is determined based on the importance levels and the device information.

The importance level refers to data reflecting an importance of a gas pipeline for achieving safe operation of a gas pipeline network. For example, the more gas users supplied by the gas pipeline and the higher the demand of the gas users for a stable gas supply, the higher the importance level of the gas pipeline.

In some embodiments, the importance level may be represented by a numerical value, and a larger numerical value indicates a higher importance level.

In some embodiments, the gas company management platform may obtain the importance level of the gas pipeline from the government safety management sub-platform.

In some embodiments, the importance level may further include a data priority corresponding to the gas pipeline.

The data priority refers to a priority level for a monitoring device to collect gas data. In some embodiments, the data priority may be represented by a numerical value.

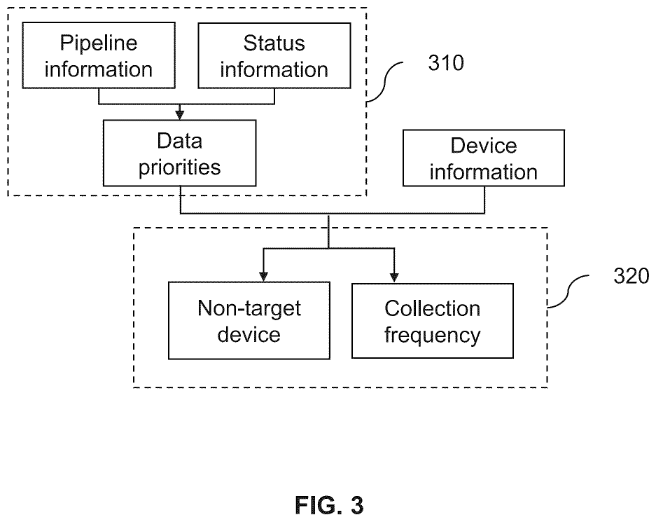

More descriptions regarding the data priority and its acquisition may be found in FIG. 3 and related descriptions thereof.

The monitoring device refers to an intelligent monitoring device for obtaining and transmitting data related to the gas pipeline. In some embodiments, the intelligent gas appliance object platform may be provided with a plurality of groups of monitoring devices.

In some embodiments, the monitoring device may include a monitoring module and a communication module. The monitoring module is a module configured to perform sensing or data collection. The monitoring module may include, but is not limited to, a flow meter, a pressure sensor, or a temperature sensor. The communication module is configured to implement data transmission with other platforms in the energy-saving monitoring IoT system or with other objects outside the energy-saving monitoring IoT system.

In some embodiments, the monitoring device may further implement functions such as data processing, early warning, alarm, or the like. Merely by way of example, the monitoring device may perform simple statistics on collected data to determine a maximum value, a minimum value, etc. As another example, in response to a determination that the collected data is not within a reasonable range or a data change trend does not conform to a normal state, the monitoring device may perform an alarm or an early warning.

In some embodiments, the gas company management platform may retrieve device information of a plurality of groups of monitoring devices corresponding to a plurality of gas pipelines from a memory.

The device information refers to information used to characterize features or attributes of the monitoring device. Merely by way of example, the device information may include the type of the monitoring device, power consumption information, etc.

The type of the monitoring device refers to which one of a flow meter, a pressure sensor, a temperature sensor, or another device the monitoring device belongs to.

The power consumption information refers to information related to a power level and a power usage situation of the monitoring device. Merely by way of example, the power consumption information includes a remaining power level and a power consumption rate. In some embodiments, the power consumption information may be obtained by the gas company management platform through real-time communication with the monitoring device, or may be estimated by the gas company management platform based on an operating time of the monitoring device and a power of the monitoring device.

The monitoring strategy refers to a strategy for data collection or transmission by the monitoring device. Merely by way of example, the monitoring strategy includes at least a set of non-target devices among the plurality of monitoring devices, and a collection frequency of each non-target device.

The non-target device refers to a monitoring device that does not require energy-saving control.

The collection frequency refers to a count of times the non-target device performs data collection per unit time.

When managing the monitoring device based on the monitoring strategy, the non-target device may perform data collection or transmission based on the collection frequency.

In some embodiments, the process of determining the monitoring strategy includes determining which monitoring devices are non-target devices and determining the collection frequency of the non-target devices.

In some embodiments, the gas company management platform may determine the monitoring strategy for the monitoring devices in the gas pipelines in a plurality of ways based on the importance levels of the gas pipelines and the device information.

In some embodiments, the gas company management platform may determine a monitoring device with an importance level greater than a level threshold as a non-target device. The level threshold refers to a critical value of the importance level used to determine whether the monitoring device is a non-target device. The level threshold may be preset based on experience.

In some embodiments, the gas company management platform may determine the collection frequency of the non-target device by querying a frequency reference table based on the type of the non-target device. The frequency reference table includes a reference type of the monitoring device and a corresponding reference collection frequency. The frequency reference table may be constructed based on prior experience.

In some embodiments, the gas company management platform may further determine the data priorities of the plurality of gas pipelines in a preset period based on pipeline information and status information of the plurality of gas pipelines. The gas company management platform may determine the non-target devices in the plurality of gas pipelines and the collection frequency of the non-target devices based on the data priorities and the device information. More descriptions may be found in FIG. 2 and related descriptions thereof.

In step 220, a target device among the plurality of sets of monitoring devices and an energy-saving level corresponding to the target device are determined at least based on the monitoring strategy, and an energy-saving control parameter is determined based on the energy-saving level.

The target device refers to a monitoring device that requires energy-saving control.

The energy-saving level refers to data characterizing the intensity of energy-saving control performed on the monitoring device. A higher energy-saving level corresponds to a greater intensity of energy-saving control performed on the monitoring device. Merely by way of example, a higher energy-saving level corresponds to a lower frequency of data collection or transmission by the monitoring device. Taking an example where the energy-saving level includes a first-level energy saving to a tenth-level energy saving, when the energy-saving level of the monitoring device is the tenth-level energy saving, the gas company management platform may control the monitoring device to be turned off.

In some embodiments, the gas company management platform may determine the target device among the monitoring devices at least based on the monitoring strategy. Merely by way of example, the gas company management platform may determine a set of non-target devices based on the monitoring strategy, and determine monitoring devices that do not belong to the set of non-target devices among the monitoring devices as the target devices.

In some embodiments, the energy-saving level of the monitoring device may be determined based on the device information of the monitoring device. Merely by way of example, a power consumption of the monitoring device and the importance level are determined from the device information. For example, a higher power consumption of the monitoring device and a lower importance level correspond to a higher energy-saving level.

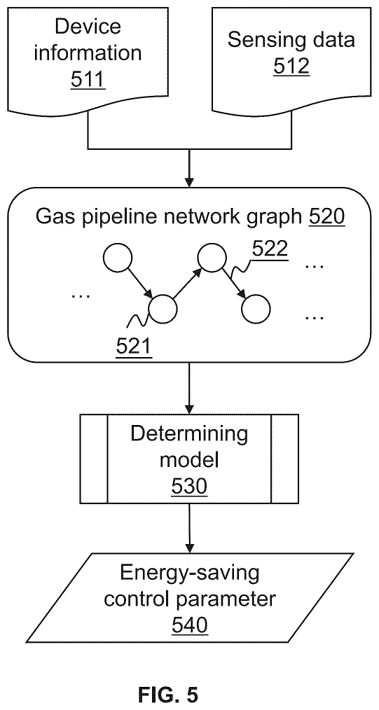

In some embodiments, the gas company management platform may further determine a temperature threshold and a sensing variation feature based on sensing data of the target device. The gas company management platform may determine the energy-saving level of the target device based on the temperature threshold and the sensing variation feature. More descriptions may be found in FIG. 5 and related descriptions thereof.

In some embodiments, the gas company management platform may determine the energy-saving control parameter of the target device based on the energy-saving level of the target device.

The energy-saving control parameter refers to a parameter used when performing energy-saving control on the monitoring device. Merely by way of example, the energy-saving control parameter includes, but is not limited to, at least one of a time node, an operating mode of the monitoring device, an energy-saving collection frequency, and a data transmission volume.

The time node refers to a key time point related to implementing energy-saving control. Merely by way of example, the time node may include a time point to start energy-saving control, a time point to end energy-saving control, a time point to start or end different operating modes of the monitoring device during the energy-saving control process, etc.

The operating mode of the monitoring device may include an off mode, a low-power mode, and an active mode.

The low-power mode refers to turning on only the monitoring module and turning off the communication module. A dynamic power management module is configured to turn on the communication module in response to an occurrence of an event of interest, and transmit sensing data collected during a period when the communication module is turned off. The event of interest refers to a situation where monitoring data of the gas pipeline is abnormal. Merely by way of example, the event of interest includes a situation where any one of temperature, humidity, or pressure exceeds a safe range. The safe range may be determined based on prior experience.

The active mode refers to turning on both the monitoring module and the communication module, continuously collecting the sensing data according to the energy-saving collection frequency, and uploading the collected sensing data according to a certain transmission frequency.

The energy-saving collection frequency refers to a count of times the target device collects data per unit time.

The data transmission volume refers to an amount of data transmitted by the monitoring device in one data transmission. The data transmission volume may be represented by a byte length of the transmitted data.

In some embodiments, the gas company management platform may determine the energy-saving control parameter of the monitoring device by querying a reference control parameter table based on an energy-saving classification of the monitoring device. A reference control parameter table may include a correspondence between reference energy-saving levels and reference control parameters. The reference control parameter table may be constructed based on prior experience.

In step 230, the energy-saving control parameter is sent to an intelligent gas government safety supervision management platform, and a control instruction is generated based on the energy-saving control parameter in response to obtaining confirmation information from the intelligent gas government safety supervision management platform.

In some cases, controlling the data collection or transmission process of a monitoring device based on the energy-saving control parameter may affect the efficiency of data collection or transmission. In this case, to avoid affecting the safe operation of the gas pipeline network, the gas company management platform may send the energy-saving control parameter to the intelligent gas government safety supervision management platform. The intelligent gas government safety supervision management platform and its corresponding supervisory user may determine whether the energy-saving control parameter is usable. If the energy-saving control parameter is usable, the intelligent gas government safety supervision management platform may send the confirmation information to the gas company management platform 131.

In some embodiments, in response to obtaining the confirmation information from the intelligent gas government safety supervision management platform, the gas company management platform may generate the control instruction based on the energy-saving control parameter. The control instruction may include the energy-saving control parameter and a target device that needs to be controlled according to the energy-saving control parameter.

In step 240, the target device is controlled to perform a target operation based on the control instruction.

In some embodiments, the control instruction is configured to control the target device to perform the target operation.

The target operation is an operation related to the operation of the target device. In some embodiments, the target operation includes at least one of adjusting an operating mode, performing data collection, and performing data transmission.

In some embodiments, the gas company management platform may control the communication module of the target device to turn on or off based on the operating mode in the energy-saving control parameter. When the communication module of the target device is turned on, the gas company management platform may control the target device to perform data transmission based on the data transmission volume via the communication module.

In some embodiments, the gas company management platform may control the target device to perform data collection according to the energy-saving collection frequency via the monitoring module to obtain the sensing data.

When a monitoring device of the gas pipeline is powered by an independent power source (such as a battery), improper management may lead to power depletion and failure to complete data collection. In such cases, maintenance personnel must be dispatched for inspection and repairs. Manual maintenance not only affects the timeliness of data acquisition but also adds additional workload.

In some embodiments of the present disclosure, a reasonable monitoring strategy is established to manage the data collection and transmission processes of the monitoring devices. This enables better planning of these operations, ensures timely data acquisition, and increases the overall available time of the monitoring devices.

FIG. 3 is a schematic diagram illustrating a process for determining a collection frequency according to some embodiments of the present disclosure. As shown in FIG. 3, the process for determining the collection frequency may include the following steps. In some embodiments, the process of determining the collection frequency may be performed by the gas company management platform.

In step 310, the data priorities of the plurality of gas pipelines in a preset period are determined based on pipeline information of the plurality of gas pipelines and status information of the plurality of gas pipelines.

The pipeline information refers to information related to the gas transmission of the gas pipeline. For example, the pipeline information may include a medium transmitted by the pipeline, a set transmission temperature, a set transmission pressure, etc. The medium transmitted by the pipeline may include a transmitted gas composition, such as methane, hydrogen, carbon monoxide, liquefied petroleum gas, etc.

In some embodiments, the gas company management platform may obtain the pipeline information of the plurality of gas pipelines from a gas company data center.

The status information refers to information about the status of gas transportation by a gas pipeline. In some embodiments, the status information may include a peak period, an off-peak period, etc.

In some embodiments, the gas company management platform may obtain gas transportation volumes of the plurality of gas pipelines in different periods from the gas company data center. The gas company management platform may determine the peak period, the off-peak period, etc., of gas transportation by categorizing the different periods based on the gas transportation volumes. For example, the gas company management platform may determine an average value of the gas transportation volumes. A period with a gas transportation volume higher than the average value may be determined as the peak period. A period with a gas transportation volume lower than the average value may be determined as the off-peak period.

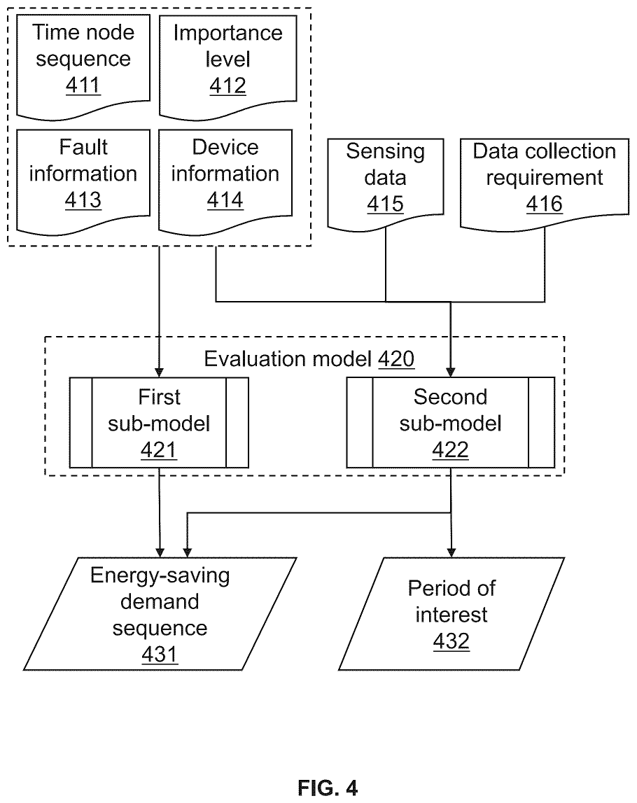

The preset period refers to a period for which a monitoring strategy needs to be determined. In some embodiments, the preset period may be determined in various ways. For example, the preset period may be a period preset by a technician (e.g., a period from 01:00 to 04:00 every day, etc.). As another example, the preset period may also be a period obtained by dividing 24 hours of a day (e.g., dividing every three hours with 0:00 as a starting point). As yet another example, the preset period may also be a period of interest output by a second sub-model of an evaluation model. More descriptions regarding the evaluation model may be found in FIG. 4 and the related description thereof.

In some embodiments, the gas company management platform may determine reference priorities of different monitoring devices on the gas pipelines by querying a priority table based on the pipeline information of the gas pipelines. The gas company management platform may determine the data priorities of the different monitoring devices by adjusting the reference priorities according to an adjustment rule based on the status information.

The priority table includes data priorities of the monitoring devices corresponding to different pipeline information. For example, the priority table includes data priorities of a temperature sensor, a pressure sensor, a flow meter, etc., corresponding to pipeline information where a transmitted medium is hydrogen, a transmission temperature is room temperature, and a transmission pressure is high pressure. In some embodiments, the priority table may be preset by a technician based on experience.

The adjustment rule refers to a rule for adjusting data priorities of multiple types of gas data. In some embodiments, the adjustment rule may include: when the status information in the preset period is the peak period, increasing the reference priority to obtain the data priority; and when the status information in the preset period is the off-peak period, decreasing the reference priority to obtain the data priority. The increasing and decreasing manners may include increasing or decreasing by a certain level (e.g., increasing by 1 level or decreasing by 1 level), amplifying or reducing to a certain multiple (e.g., amplifying to 1.2 times or reducing to 0.8 times), etc.

In step 320, the non-target device among the plurality of sets of monitoring devices and the collection frequency of the non-target device are determined based on the data priorities and the device information.

The non-target device refers to a monitoring device that does not require energy-saving control.

In some embodiments, for monitoring devices on different gas pipelines, an estimated collection frequency of a monitoring device is determined based on the data priority of the monitoring device and a power consumption rate. A monitoring device with the estimated collection frequency greater than a preset frequency threshold is determined as the non-target device. The preset frequency threshold may be set by a technician based on prior experience. The estimated collection frequency may be determined by the following formula (1):

$$F = \frac{k \times P}{{v}_{e}} , \qquad ( 1 )$$

where F denotes the estimated collection frequency; vₑ denotes the power consumption rate; P denotes the data priority; and k denotes a conversion coefficient, and k>0. The power consumption rate is an amount of power consumed by a collection device per unit time. In some embodiments, the power consumption rate may be determined based on a change in battery power of the collection device in a historical period.

It may be understood that the faster the power consumption rate and the lower the data priority, the more necessary it is to save electrical energy, i.e., the lower the estimated collection frequency.

In some embodiments, the gas company management platform may use a standard collection frequency as the collection frequency of the non-target device. The standard collection frequency is a collection frequency that may meet monitoring requirements without considering power consumption. In some embodiments, the standard collection frequency may be set based on historical experience.

In some embodiments, the gas company management platform may transmit a collection frequency of a non-target device to a corresponding non-target device through an intelligent gas sensing network platform, to control the non-target device to perform data collection in a preset period according to the collection frequency.

In some embodiments of the present disclosure, the data priorities are determined based on the pipeline information and the status information. The data priorities are used to identify non-target devices exempt from energy saving measures and set their collection frequency. This approach maintains sufficient data collection while conserving energy, thereby ensuring normal pipeline operation.

In some embodiments, the gas company management platform may further determine an estimated power consumption rate and an estimated remaining power of each of the plurality of sets of monitoring devices at one or more time points in the preset period based on historical power consumption information of each of the plurality of sets of monitoring devices; in response to existence of a warning time point at which the estimated remaining power is not higher than a warning power level, generate warning information based on the warning time point and send the warning information to an associated user terminal; and in response to the estimated remaining power of the non-target device not being higher than the warning power level, adjust the collection frequency based on a preset rule, and control the non-target device to perform data collection based on the adjusted collection frequency.

The power consumption information refers to the power usage information of a monitoring device. Merely by way of example, the power consumption information includes power consumed by the monitoring device each time power collection is performed, remaining power, etc.

The estimated power consumption rate refers to an estimated rate at which a monitoring device consumes power in a future period. The estimated remaining power refers to a predicted remaining power of a monitoring device at a future time point.

In some embodiments, the gas company management platform may perform time series analysis on the historical power consumption information arranged in chronological order to determine the estimated power consumption rate and the estimated remaining power.

The warning power level refers to a power threshold that indicates power is about to be exhausted.

In some embodiments, the warning power level is obtained in various ways. For example, the warning power level is preset by a technician based on historical experience.

In some embodiments, the warning power level is related to at least one of historical energy-saving control parameters of the monitoring device or a sensing variation feature.

The historical energy-saving control parameter refers to an energy-saving control parameter executed by a monitoring device in a historical period. More descriptions regarding the energy-saving control parameter may be found in FIG. 1 and related descriptions thereof.

In some embodiments, the gas company management platform directly reads the historical energy-saving control parameters of the monitoring devices from the gas company data center.

In some embodiments, the warning power level is positively correlated with a change frequency of an operating mode in the historical energy-saving control parameter. For example, the gas company management platform may adjust the warning power level according to the change frequency of the operating mode, where a higher change frequency corresponds to a higher warning power level. The change frequency of the operating mode refers to a count of times the operating mode is switched per unit time.

In some embodiments, the gas company management platform performs statistics on the historical energy-saving control parameters of the monitoring devices to determine the change frequency of the operating mode. It is understandable that a higher change frequency of the operating mode leads to more inconsistent power consumption rates and less accurate prediction of the remaining power, so the warning power level needs to be increased to prevent power exhaustion.

In some embodiments, the warning power level is positively correlated with the sensing variation feature. It is understandable that a smaller sensing variation feature indicates smaller data change monitored by the monitoring device and a relatively stable power consumption rate, so the warning power level may be appropriately reduced. More descriptions regarding the sensing variation feature may be found in FIG. 5 and related descriptions thereof.

In some embodiments, when a frequency of being in an active mode in the operating mode of the historical energy-saving control parameter is greater than a mode threshold, the gas company management platform may adjust the warning power level only based on the sensing variation feature, without considering the impact of a change in the historical energy-saving control parameter on the warning power level.

In some embodiments of the present disclosure, the warning power level is adjusted based on the historical energy-saving control parameter and the sensing variation feature. This helps reduce the impact of errors in the estimated power consumption rate and the estimated remaining power on the monitoring device, thereby avoiding premature power exhaustion.

The warning time point refers to a time point at which a power situation needs to be warned. In some embodiments, the warning time point includes a time point at which the estimated remaining power is not higher than the warning power level.

The warning information refers to information related to warning of a power situation. In some embodiments, the warning information includes an estimated remaining power of a monitoring device that needs warning and a warning time point, etc.

In some embodiments, when a warning time point exists, the gas company management platform transmits the estimated remaining power and the warning time point to a user terminal of a gas user, so as to remind maintenance personnel or management personnel to replace a battery of the monitoring device, etc.

The preset rule refers to a rule for adjusting an operating frequency. In some embodiments, the preset rule may determine an adjustment magnitude of the operating frequency through a percentage difference between the estimated remaining power and a power threshold.

In some embodiments, the gas company management platform may transmit the adjusted collection frequency to a corresponding non-target device in a gas appliance object platform, so as to replace an original collection frequency thereof, so that the non-target device performs data collection according to the adjusted collection frequency.

In some embodiments of the present disclosure, the warning time point is determined based on the estimated remaining power. This enables timely battery replacement for the monitoring devices with insufficient power. Meanwhile, adjusting the collection frequency for the non-target devices with low estimated remaining power ensures certain data collection capability before battery replacement, thus guaranteeing effective monitoring of the gas pipelines.

FIG. 4 is a schematic diagram illustrating an evaluation model according to some embodiments of the present disclosure.

In some embodiments, the gas company management platform may determine an energy-saving management demand of the plurality of gas pipelines in a future period through an evaluation model 420. In response to the energy-saving management demand being that an energy-saving management is required, the gas company management platform may determine the monitoring strategy based on the importance levels of the plurality of gas pipelines and the device information.

More descriptions regarding the importance level, the device information, and the monitoring strategy may be found in FIG. 2 and related descriptions thereof. More descriptions regarding the preset period may be found in FIG. 3 and related descriptions thereof.

The evaluation model is a model for determining an energy-saving management demand of a gas pipeline in a future period. In some embodiments, the evaluation model is a machine learning model. For example, the evaluation model is a recurrent neural network (RNN) model or another trained machine learning model.

An input of the evaluation model includes a time node sequence, the importance levels of the plurality of gas pipelines, fault information, and the device information of the plurality of monitoring devices corresponding to the plurality of gas pipelines. An output of the evaluation model includes an energy-saving demand sequence corresponding to the time node sequence.

The energy-saving management demand refers to the overall demand of the plurality of monitoring devices in the plurality of gas pipelines for energy-saving management. The energy-saving management demand includes that the energy-saving management is required, and the energy-saving management is not required.

The time node sequence refers to a sequence composed of a plurality of time nodes in a future period arranged in chronological order. In some embodiments, the gas company management platform divides the future period into a plurality of time nodes according to a second time interval to obtain the time node sequence. The future period is set based on historical experience. The second time interval is less than a first time interval. More descriptions regarding the first time interval may be found in FIG. 2 and related descriptions thereof.

In some embodiments, the time node sequence further includes a current time node.

The fault information refers to information related to a fault occurring in a plurality of gas pipelines. The fault information includes a fault time, a monitoring device where the fault occurs, etc. In some embodiments, the gas company management platform obtains the fault information reported by a gas user through a user terminal via a gas company sensing network platform.

The energy-saving demand sequence refers to a sequence composed of energy-saving management demands at a plurality of time nodes. An element in the energy-saving demand sequence corresponds to an energy-saving management demand at a time point. The elements are arranged in chronological order of the time points, and the time point of each element corresponds to an element in the time node sequence.

In some embodiments, the gas company management platform obtains the evaluation model through training based on a plurality of first training samples with first labels. The gas company management platform may input the plurality of first training samples into an initial evaluation model. A loss function is constructed based on an output of the initial evaluation model and the first labels. Parameters of the initial evaluation model are iteratively updated based on the loss function. The iteration ends when an iteration completion condition is satisfied, and a trained evaluation model is obtained. Manners for the iterative updating include, but are not limited to, a gradient descent manner, or the like. The iteration completion condition includes convergence of the loss function or an iteration count reaching a threshold.

The plurality of first training samples include a sample time node sequence, an importance level of a sample gas pipeline, sample fault information, and sample device information. The plurality of first training samples may be obtained based on historical data.

In some embodiments, the gas company management platform determines energy-saving management demands of all sample monitoring devices in the sample gas pipeline at each sample time node based on the importance level of the sample gas pipeline and the sample fault information. For example, in response to the importance levels of all sample monitoring devices at a sample time node being greater than a level threshold, and no fault occurs in all sample monitoring devices at the sample time node, the energy-saving management demand of the sample gas pipeline at the sample time node is that an energy-saving management is not required. Otherwise, the energy-saving management demand of the sample gas pipeline at the sample time node is that the energy-saving management is required. The gas company management platform combines the energy-saving management demands of the sample gas pipeline at all sample time nodes to obtain a first label corresponding to the first training sample.

In some embodiments, as shown in FIG. 4, the evaluation model 420 includes a first sub-model 421 and a second sub-model 422.

An input of the first sub-model 421 includes a time node sequence 411, an importance level 412 of the plurality of gas pipelines, fault information 413, and device information 414 of the plurality of monitoring devices corresponding to the plurality of gas pipelines. An output of the first sub-model 421 includes an energy-saving demand sequence 431 corresponding to the time node sequence 411.

An input of the second sub-model 422 includes the time node sequence 411, the importance level 412 of the plurality of gas pipelines, the fault information 413, the device information 414, sensing data 415 of the plurality of monitoring devices, and a data collection requirement 416. An output of the second sub-model 422 includes an energy-saving demand sequence 431 and a period of interest 432.

In some embodiments, the gas company management platform evaluates the energy-saving management demand of the gas pipeline based on the first sub-model in response to the data priority meets a preset condition. The gas company management platform evaluates the energy-saving management demand of the gas pipeline based on the second sub-model in response to the data priority of the gas pipeline not meeting the preset condition.

More descriptions regarding the sensing data of the monitoring device may be found in FIG. 2 and related descriptions thereof.

The first sub-model is the same as the evaluation model described above. More descriptions regarding the evaluation model may be found in the related descriptions above.

The second sub-model is also a model for determining the energy-saving management demand of the gas pipeline in a future period. Compared with the first sub-model, the second sub-model is more complex.

The data collection requirement refers to a requirement of the gas company management platform for collecting the sensing data. For example, the data collection requirement includes a type of sensing data to be collected and a corresponding time. In some embodiments, the data collection requirement is a system preset value or manually set by management personnel.

The period of interest refers to a period recommended for energy-saving management. The period of interest includes one or more future time nodes.

In some embodiments, the gas company management platform obtains the second sub-model through training based on a plurality of second training samples with second labels. The training process of the second sub-model is similar to that of the first sub-model. More descriptions regarding the process for training the second sub-model may be found in the related descriptions above.

The plurality of second training samples includes the sample time node sequence, the importance level of the sample gas pipeline, the sample fault information, the sample device information, the sensing data of the sample monitoring device, and a sample data collection requirement. The plurality of second training samples may be obtained based on historical data.

In some embodiments, the gas company management platform obtains, from the sensing data of the sample monitoring device, a period corresponding to flow data being greater than a preset flow threshold, a period corresponding to temperature data being less than a preset temperature threshold, and a period corresponding to the sample data collection requirement. A label period is obtained by combining the periods. The first label and the label period are determined as a second label corresponding to the second training sample. The preset flow threshold and the preset temperature threshold may be set based on historical experience.

In some embodiments, in response to the data priority meeting the preset condition, the gas company management platform may evaluate the energy-saving management demand of the gas pipeline based on the first sub-model. In response to the data priority of the gas pipeline not meeting the preset condition, the gas company management platform may evaluate the energy-saving management demand of the gas pipeline based on the second sub-model. The preset condition may be that the data priority of the gas pipeline is not greater than a preset priority threshold. The preset priority threshold may be a system preset value.

In some embodiments of the present disclosure, when the data priority of the gas pipeline meets the preset condition, the first sub-model is used to determine the energy-saving management demand, which can improve evaluation efficiency and save time. When the data priority of the gas pipeline does not meet the preset condition, the second sub-model is used to determine the energy-saving management demand, which not only obtains a more accurate energy-saving demand sequence but also obtains the period of interest, contributing to better energy-saving management of the gas pipeline.

In some embodiments, in response to the energy-saving management demand of the gas pipeline in the preset period being that the energy-saving management is required, the gas company management platform may determine a monitoring strategy based on the importance level of the gas pipeline and the device information. More descriptions may be found in FIG. 2 in the related descriptions above.

In some embodiments of the present disclosure, by determining the energy-saving management demand of the gas pipeline at each time node, and only classifying monitoring devices and performing subsequent operations at the time node when an energy-saving management is required, the data processing volume can be effectively reduced, thereby saving computational resources and energy consumption.

FIG. 5 is a schematic diagram illustrating an exemplary process for determining an energy-saving control parameter according to some embodiments of the present disclosure.

In some embodiments, the gas company management platform determines the target device based on the monitoring strategy. The gas company management platform invokes sensing data collected by the target device from the gas appliance object platform via the gas company sensing network platform. A minimum temperature and a sensing variation feature are determined based on the sensing data of the target device. An energy-saving level of the target device is determined based on the minimum temperature and the sensing variation feature. The energy-saving control parameter is determined based on the energy-saving level.

More descriptions regarding the monitoring strategy, the sensing data, the energy-saving level, and the energy-saving control parameter may be found in FIG. 2 and related descriptions thereof.

More descriptions regarding the determination of the target device based on the monitoring strategy may be found in FIG. 2 and related descriptions thereof.

The temperature threshold is a minimum temperature of an environment where the monitoring device is located.

In some embodiments, the gas company management platform may determine minimum temperature data based on the sensing data of the target device and determine the minimum temperature data as the temperature threshold.

The sensing data is data reflecting characteristics of the gas pipeline. For example, the sensing data may include, but is not limited to, at least one of flow data, pressure data, and temperature data, which may reflect a gas flow rate, a pressure, and a temperature in the gas pipeline.

In some embodiments, the gas company management platform may invoke the sensing data collected by the target device from the gas appliance object platform through the gas company sensing network platform.

The sensing variation feature refers to a feature related to a variation condition of the sensing data of the target device. As an example, the sensing variation feature includes a temperature variation frequency, a pressure variation frequency, a flow variation frequency, etc. In some embodiments, the gas company management platform determines the sensing variation feature based on temperature data, pressure data, and flow data in historical data of the target device or collected in real time.

In some embodiments, the gas company management platform determines an energy-saving level of the target device based on a minimum temperature, a sensing variation feature, and a collection frequency. For example, the energy-saving level is positively correlated with the minimum temperature, a temperature variation frequency, a pressure variation frequency, and a flow rate variation frequency, and is negatively correlated with the collection frequency. In some embodiments, the gas company management platform determines the energy-saving level of the target device using the following formula (2).

$${G}_{1} = \frac{a \times {T}_{min} + b \times {F}_{t} + c \times {F}_{p} + d \times {F}_{f}}{k \times {F}_{s}} \qquad ( 2 )$$

where G₁ denotes the energy-saving level of the target device; Tₘᵢₙ denotes the minimum temperature; Fₜ denotes the temperature variation frequency; Fₚ denotes the pressure variation frequency; F_{f} denotes the flow rate variation frequency; Fₛ denotes the collection frequency; a, b, c, and d denote weight coefficients; and k denotes a conversion coefficient corresponding to the collection frequency. a, b, c, d, and k may be set based on experience.

In some embodiments, c and d are negatively correlated with a consistency between historical sensing data and historical status information of the target device.

The consistency between the historical sensing data and the historical status information reflects a degree of agreement between the historical sensing data and the historical status information. A higher consistency indicates that the historical sensing data and the historical status information match better, and a monitoring strategy determined based on pressure data and flow rate data is more accurate. In this case, weights corresponding to the pressure variation frequency and the flow rate variation frequency need to be reduced, i.e., c and d are reduced. If c and d are reduced to 0, it indicates that the influence of the pressure variation frequency and the flow rate variation frequency is not considered.

In some embodiments, the gas company management platform compares a curve of the historical status information with a curve of the historical sensing data, and determines the consistency between the historical sensing data and the historical status information based on a comparison result. For example, if the historical status information changes at a certain historical time node, the historical sensing data should change synchronously. The gas company management platform determines the consistency between the historical sensing data and the historical status information based on an interval between historical time nodes corresponding to the same change in the historical status information and the historical sensing data. A shorter interval indicates a higher consistency.

In some embodiments, as shown in FIG. 5, the gas company management platform constructs a gas pipeline network graph 520 based on device information 511 of the target device and sensing data 512 of the target device. The gas company management platform determines an energy-saving control parameter 540 through a determining model 530 based on the gas pipeline network graph 520.

More descriptions regarding the device information may be found in FIG. 2 and related descriptions thereof.

The gas pipeline network graph refers to a graph structure reflecting the sensing data collection situation in the gas pipeline network. In some embodiments, the gas pipeline network graph includes a plurality of nodes 521 and a plurality of edges 522 connecting the nodes.

Each node in the gas pipeline network graph corresponds to one target device.

In some embodiments, a node feature in the gas pipeline network graph includes device information and sensing data of the target device corresponding to the node.

An edge connecting two nodes in the gas pipeline network graph indicates that the two nodes are connected via a gas pipeline, and a direction of the edge is a gas flow direction between the two nodes. In some embodiments, the gas company management platform determines the gas flow direction based on a connection relationship of the gas pipelines.

In some embodiments, an edge feature in the gas pipeline network graph includes the pipeline information and an importance level of the gas pipeline.

More descriptions regarding the importance level of the gas pipeline may be found in FIG. 2 and related descriptions thereof. More descriptions regarding the pipeline information may be found in FIG. 3 and related descriptions thereof.

The determining model is a model for determining the energy-saving control parameter. In some embodiments, the determining model is a machine learning model. For example, the determining model is a graph neural network (GNN) model, or other machine learning model obtained through training.

An input of the determining model includes the gas pipeline network graph. An output of the determining model includes an energy-saving control parameter corresponding to each node in the gas pipeline network graph.

In some embodiments, the gas company management platform obtains the determining model through training based on a plurality of third training samples with third labels. The training process of the determining model is similar to that of the first sub-model. More descriptions may be found in FIG. 4 and related descriptions thereof.

In some embodiments, the gas company management platform determines an energy-saving score of a historical target device based on historical device information at a certain historical time node, determines a safety score of the historical target device based on historical fault information at the historical time node, and calculates a total score of the historical target device through weighted summation. In response to an average value of total scores of a plurality of historical target devices being greater than a preset score threshold, the gas company management platform constructs a sample gas pipeline network graph based on the historical device information and historical sensing data of the historical target device at the historical time node, and determines the sample gas pipeline network graph as a third training sample. The weights for the weighted summation and the preset score threshold may be set based on experience. More descriptions regarding the fault information may be found in FIG. 4 and related descriptions thereof.

In some embodiments, the energy-saving score of the historical target device is negatively correlated with historical power consumption information in the historical device information. The safety score of the historical target device is negatively correlated with a count of times a fault occurs in the historical fault information.

In some embodiments, the gas company management platform determines an energy-saving control parameter actually used by each node in the sample gas pipeline network graph as the third label.

In some embodiments of the present disclosure, the energy-saving control parameter is determined through the determining model based on the gas pipeline network graph, which enables simultaneous determination of energy-saving control parameters for a plurality of target devices, thereby achieving unified management of the plurality of target devices. Using the machine learning model to determine the energy-saving control parameter may improve the efficiency and accuracy of determining the energy-saving control parameter.

In some embodiments, during operation of the target device based on the energy-saving control parameter, in response to a current remaining power of the target device not being higher than a power threshold, the target device adjusts the energy-saving control parameter, and the gas company management platform may adjust an initial flow rate of a target pipeline where the target device is located to determine an updated flow rate value. The gas company management platform may determine an opening degree of a flow valve in the target pipeline based on the updated flow rate value, and control the flow valve to adjust based on the opening degree. In response to the current remaining power of the target device being higher than the power threshold, the gas company management platform may control the target pipeline to perform gas delivery according to the initial flow rate, and re-determine the energy-saving control parameter.

More descriptions regarding the remaining power and the power threshold may be found in FIG. 3 and related descriptions thereof.

In some embodiments, in response to a historical energy-saving control parameter of the target device satisfying a power upload condition, the target device uploads the current remaining power to a remote-control terminal.

The power upload condition is used to determine whether the target device uploads the current remaining power. In some embodiments, the power upload condition is that a cumulative working duration of the target device is greater than a preset duration threshold, or a cumulative data transmission volume is greater than a preset data volume threshold. The preset duration threshold and the preset data volume threshold may be set based on historical experience.

In some embodiments, in response to the current remaining power of the target device not being higher than the power threshold, the target device automatically adjusts the energy-saving control parameter, and the gas company management platform adjusts the initial flow rate of the target pipeline where the target device is located to determine the updated flow rate value. Adjustment of the energy-saving control parameter includes, but is not limited to, one or more of selecting an operating mode with lower power consumption based on priority in sequence, reducing the collection frequency, reducing the data transmission volume, etc.

The target pipeline refers to a gas pipeline where the target device, whose current remaining power is not higher than the power threshold, is located.

The updated flow rate value refers to a flow rate obtained after adjusting the initial flow rate.

In some embodiments, the updated flow rate value is positively correlated with a current remaining power percentage of the target device. The gas company management platform may determine the updated flow rate value using the following formula (3).

$$F {T}_{n} = ( F {T}_{o} - F {T}_{m} ) \times {P}_{e} + F {T}_{m} , \qquad ( 3 )$$

where FTₙ denotes the updated flow rate value; FTₒ denotes the initial flow rate; FTₘ denotes a minimum flow rate; and Pₑ denotes the current remaining power percentage. FTₘ may be a system default value.

In some embodiments, control of the flow rate is achieved by changing the opening degree of the flow valve in the target pipeline. The larger the opening degree of the flow valve, the larger the flow rate.

In some embodiments, the gas company management platform determines an opening degree of the flow valve by querying an opening degree-flow rate comparison table based on the updated flow rate value.

The opening degree-flow rate comparison table includes a correspondence between an opening degree of the flow valve and a flow rate. The opening degree-flow rate comparison table is determined based on experiments.

In some embodiments, the current remaining power of the target device is higher than the power threshold, indicating that the target device has completed charging or battery replacement. In this case, the gas company management platform controls the target pipeline to perform gas delivery according to the initial flow rate, and re-determines the energy-saving control parameter by querying a control parameter reference table or through the determining model. More descriptions regarding the process for determining the energy-saving control parameter by querying the control parameter reference table may be found in FIG. 2 and related descriptions thereof.

In some embodiments of the present disclosure, when the remaining power of the target device is low, the target device operates with lower power consumption while reducing the gas flow rate. This sacrifices part of gas usage efficiency to ensure the stability of the gas supply. After the target device completes charging or battery replacement, restoring the flow rate to the initial flow rate and re-determining the energy-saving control parameter improves gas usage efficiency and effectively achieves energy-saving management.

In some embodiments of the present disclosure, determining the energy-saving level of the target device based on the minimum temperature and the sensing variation feature enables the determination of a more reasonable energy-saving level based on more influencing factors. Performing energy-saving management based on the energy-saving level further reduces energy consumption and saves costs.

The basic concepts have been described above. Obviously, to a person skilled in the art, the foregoing detailed disclosure is merely an example and does not constitute a limitation to the present disclosure. Although not explicitly stated herein, a person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe the embodiments of the present disclosure. For example, “an embodiment,” “one embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different locations in the present disclosure does not necessarily refer to the same embodiment. In addition, certain features, structures, or characteristics in one or more embodiments of the present disclosure may be appropriately combined.

Finally, it should be understood that the embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. An energy-saving monitoring method for an intelligent gas pipeline device, executed by a gas company management platform of an energy-saving monitoring Internet of Things (IoT) system for the intelligent gas pipeline device, comprising:
obtaining importance levels of a plurality of gas pipelines from a data center of a government safety management sub-platform, invoking device information of a plurality of sets of monitoring devices corresponding to the plurality of gas pipelines, and determining a monitoring strategy based on the importance levels and the device information, wherein each of the plurality of sets of monitoring devices includes a monitoring module and a communication module;
determining a target device among the plurality of sets of monitoring devices and an energy-saving level corresponding to the target device at least based on the monitoring strategy, and determining an energy-saving control parameter based on the energy-saving level, wherein the energy-saving control parameter includes at least one of an operating mode of the target device, an energy-saving collection frequency, and a data transmission volume; and
sending the energy-saving control parameter to an intelligent gas government safety supervision management platform, and generating a control instruction based on the energy-saving control parameter in response to obtaining confirmation information from the intelligent gas government safety supervision management platform;
wherein the control instruction is configured to control the target device to perform at least one of the following operations:
controlling the communication module of the target device to turn on or turn off based on the operating mode in the energy-saving control parameter,
controlling the target device to perform data collection according to the energy-saving collection frequency via the monitoring module, and
controlling the target device to perform data transmission based on the data transmission volume via the communication module.

2. The method according to claim 1, wherein the importance levels further include data priorities, and the monitoring strategy includes a non-target device and a collection frequency corresponding to the non-target device,
the method further comprises:
determining the data priorities of the plurality of gas pipelines in a preset period based on pipeline information of the plurality of gas pipelines and status information of the plurality of gas pipelines;
determining the non-target device among the plurality of sets of monitoring devices and the collection frequency of the non-target device based on the data priorities and the device information; and
controlling the non-target device to perform data collection in the preset period based on the collection frequency.

3. The method according to claim 2, wherein the device information further includes power consumption information of the plurality of sets of monitoring devices,
the method further comprises:
determining an estimated power consumption rate and an estimated remaining power of each of the plurality of sets of monitoring devices at one or more time points in the preset period based on historical power consumption information of each of the plurality of sets of monitoring devices;
in response to existence of a warning time point at which the estimated remaining power is not higher than a warning power level, generating warning information based on the warning time point and sending the warning information to an associated user terminal; and
in response to the estimated remaining power of the non-target device not being higher than the warning power level, adjusting the collection frequency based on a preset rule, and controlling the non-target device to perform data collection based on the adjusted collection frequency, wherein the preset rule is related to the estimated remaining power and the warning power level.

4. The method according to claim 3, wherein the warning power level is related to at least one of a historical control parameter and a sensing variation feature of each of the plurality of sets of monitoring devices.

5. The method according to claim 2, further comprising:
determining an energy-saving management demand of the plurality of gas pipelines in a future period through an evaluation model, wherein the evaluation model is a machine learning model; and
in response to the energy-saving management demand being that an energy-saving management is acquired, determining the monitoring strategy based on the importance levels of the plurality of gas pipelines and the device information.

6. The method according to claim 5, wherein the evaluation model includes a first sub-model and a second sub-model;
an input of the first sub-model includes a time node sequence, the importance levels of the plurality of gas pipelines, fault information, and the device information of the plurality of monitoring devices corresponding to the plurality of gas pipelines, and an output of the first sub-model includes an energy-saving demand sequence corresponding to the time node sequence; and
an input of the second sub-model includes the time node sequence, the importance levels of the plurality of gas pipelines, the fault information, the device information, sensing data of the plurality of monitoring devices, and a data collection requirement, and an output of the second sub-model includes the energy-saving demand sequence and a period of interest;
the method further comprises:
in response to the data priorities meeting a preset condition, evaluating the energy-saving management demand of the plurality of gas pipelines based on the first sub-model; and
in response to the data priorities not meeting the preset condition, evaluating the energy-saving management demand of the plurality of gas pipelines based on the second sub-model.

7. The method according to claim 1, further comprising:
determining the target device based on the monitoring strategy;
invoking sensing data collected by the target device from a gas appliance object platform via a gas company sensing network platform;
determining a temperature threshold and a sensing variation feature based on the sensing data of the target device;
determining the energy-saving level of the target device based on the temperature threshold and the sensing variation feature; and
determining the energy-saving control parameter based on the energy-saving level.

8. The method according to claim 7, further comprising:
constructing a gas pipeline network graph based on the device information of the target device and the sensing data; and
determining the energy-saving control parameter through a determining model based on the gas pipeline network graph, wherein the determining model is a machine learning model.

9. The method according to claim 7, further comprising:
during operation of the target device based on the energy-saving control parameter, in response to a current remaining power of the target device being not higher than a power threshold, adjusting the energy-saving control parameter, adjusting an initial flow rate of a target pipeline where the target device is located, and determining an updated flow rate value;
determining an opening degree of a flow valve in the target pipeline based on the updated flow rate value, and controlling the flow valve to adjust based on the opening degree; and
in response to the current remaining power of the target device being higher than the power threshold, controlling the target pipeline to perform gas delivery according to the initial flow rate and re-determining the energy-saving control parameter.

10. An energy-saving Internet of Things (IoT) system for an intelligent gas pipeline device, comprising an intelligent gas government safety supervision management platform, an intelligent gas government safety supervision sensing network platform, an intelligent gas government safety supervision object platform, a gas company sensing network platform, and a gas appliance object platform;
wherein the intelligent gas government safety supervision object platform includes a gas company management platform, and the gas company management platform is configured to:
obtain importance levels of a plurality of gas pipelines from a data center of a government safety management sub-platform, invoke device information of a plurality of sets of monitoring devices corresponding to the plurality of gas pipelines, and determine a monitoring strategy based on the importance levels and the device information, wherein each of the plurality of sets of monitoring devices includes a monitoring module and a communication module;
determine a target device among the plurality of sets of monitoring devices and an energy-saving level corresponding to the target device at least based on the monitoring strategy, and determine an energy-saving control parameter based on the energy-saving level, wherein the energy-saving control parameter includes at least one of an operating mode of the target device, an energy-saving collection frequency, and a data transmission volume; and
send the energy-saving control parameter to an intelligent gas government safety supervision management platform, and generate a control instruction based on the energy-saving control parameter in response to obtaining confirmation information from the intelligent gas government safety supervision management platform;
wherein the control instruction is configured to control the target device to perform at least one of the following operations:
controlling the communication module of the target device to turn on or turn off based on the operating mode in the energy-saving control parameter,
controlling the target device to perform data collection according to the energy-saving collection frequency via the monitoring module, and
controlling the target device to perform data transmission based on the data transmission volume via the communication module.

11. The system according to claim 10, wherein the importance levels further include data priorities, the monitoring strategy includes a non-target device and a collection frequency corresponding to the non-target device, and
the gas company management platform is further configured to:
determine the data priorities of the plurality of gas pipelines in a preset period based on pipeline information of the plurality of gas pipelines and status information of the plurality of gas pipelines;
determine the non-target device among the plurality of sets of monitoring devices and the collection frequency of the non-target device based on the data priorities and the device information; and
control the non-target device to perform data collection in the preset period based on the collection frequency.

12. The method of claim 11, wherein the device information further includes power consumption information of the plurality of sets of monitoring devices, and
the gas company management platform is further configured to:
determine an estimated power consumption rate and an estimated remaining power of each of the plurality of sets of monitoring devices at one or more time points in the preset period based on historical power consumption information of each of the plurality of sets of monitoring devices;
in response to existence of a warning time point at which the estimated remaining power is not higher than a warning power level, generate warning information based on the warning time point and sending the warning information to an associated user terminal; and
in response to the estimated remaining power of the non-target device not being higher than the warning power level, adjust the collection frequency based on a preset rule, and control the non-target device to perform data collection based on the adjusted collection frequency, wherein the preset rule is related to the estimated remaining power and the warning power level.

13. The system of claim 12, wherein the warning power level is related to at least one of a historical control parameter and a sensing variation feature of each of the plurality of sets of monitoring devices.

14. The system of claim 11, wherein the gas company management platform is further configured to:
determine an energy-saving management demand of the plurality of gas pipelines in a future period through an evaluation model, wherein the evaluation model is a machine learning model; and
in response to the energy-saving management demand being that an energy-saving management is required, determine the monitoring strategy based on the importance levels of the plurality of gas pipelines and the device information.

15. The system of claim 14, wherein the evaluation model includes a first sub-model and a second sub-model;
an input of the first sub-model includes a time node sequence, the importance levels of the plurality of gas pipelines, fault information, and the device information of the plurality of monitoring devices corresponding to the plurality of gas pipelines, and an output of the first sub-model includes an energy-saving demand sequence corresponding to the time node sequence;
an input of the second sub-model includes the time node sequence, the importance levels of the plurality of gas pipelines, the fault information, the device information, sensing data of the plurality of monitoring devices, and a data collection requirement, and an output of the second sub-model includes the energy-saving demand sequence and a period of interest; and
the gas company management platform is further configured to:
in response to the data priorities of the plurality of gas pipelines meeting a preset condition, evaluate the energy-saving management demand of the plurality of gas pipelines based on the second sub-model.

16. The system of claim 10, wherein the gas company management platform is further configured to:
determine the target device based on the monitoring strategy;
invoke sensing data collected by the target device from a gas appliance object platform via a gas company sensing network platform;
determine a temperature threshold and a sensing variation feature based on the sensing data of the target device;
determine the energy-saving level of the target device based on the temperature threshold and the sensing variation feature; and
determine the energy-saving control parameter based on the energy-saving level.

17. The system of claim 16, wherein the gas company management platform is further configured to:
construct a gas pipeline network graph based on the device information of the target device and the sensing data; and
determine the energy-saving control parameter through a determining model based on the gas pipeline network graph, wherein the determining model is a machine learning model.

18. The system of claim 16, wherein the gas company management platform is further configured to:
during operation of the target device based on the energy-saving control parameter, in response to a current remaining power of the target device being not higher than a power threshold, adjust the energy-saving control parameter, adjust an initial flow rate of a target pipeline where the target device is located, and determine an updated flow rate value;
determine an opening degree of a flow valve in the target pipeline based on the updated flow rate value, and control the flow valve to adjust based on the opening degree; and
in response to the current remaining power of the target device being higher than the power threshold, control the target pipeline to perform gas delivery according to the initial flow rate and re-determining the energy-saving control parameter.

19. A computer-readable storage medium, wherein the storage medium stores computer instructions, and when a computer reads the computer instructions from the storage medium, the computer executes the energy-saving monitoring method for the intelligent gas pipeline device according to claim 1.
